(19) United States
(12) Patent Application Publication
(10) Pub. No.: US 2006/0208471 A1
(43) Pub. Date: Sep. 21, 2006

(54) INFLATABLE SEATBELT SYSTEM

(75) Inventors: Srinivasan Sundararajan, Ann Arbor, MI (US); Stephen Rouhana, Plymouth, MI (US); Sundeep Kankanala, Ann Arbor, MI (US); Dean Jaradi, Macomb, MI (US)

Correspondence Address: ARTZ & ARTZ, P.C., 28333 TELEGRAPH ROAD, SUITE 250, SOUTHFIELD, MI, 48034, US

(73) Assignee: Ford Global Technologies, LLC, Dearborn, MI (US)

(21) Appl. No.: 11/277,844

(22) Filed: Mar. 29, 2006

Related U.S. Application Data
(63) Continuation-in-part of application No. 10/906,078, filed on Feb. 2, 2005.

(51) Int. Cl. B60R 21/18

(52) U.S. Cl. 280/733

(57) ABSTRACT

An inflatable seatbelt system (“seatbelt system”) for a vehicle. The seatbelt system includes a shoulder belt anchor, a first lap belt anchor, a second lap belt anchor, an inflatable seatbelt, an inflator device, one or more crash sensors, a lap belt buckle, and a seatbelt fastener. The inflatable seatbelt extends between the shoulder belt anchor and the first lap belt anchor with the inflator device fixedly attached to the first lap belt anchor. The inflator device is actuated by the crash sensors to inflate the inflatable airbag. Furthermore, the second lap belt anchor has the lap belt buckle extending therefrom, which is selectively fastened to the seatbelt fastener that is slidable on the inflatable seatbelt.

### CROSS-REFERENCE TO RELATED APPLICATIONS

This is a continuation-in-part of U.S. non-provisional application Ser. No. 10/906,078 filed on Feb. 2, 2005, entitled “BELT GUIDE APPARATUS FOR A SEATBELT RESTRAINT SYSTEM OF A VEHICLE” (Attorney Docket No. 81107535/FGT 1950 PA), and relates to U.S. non-provisional application Ser. No. ______ filed concurrently herewith on Mar. 29, 2006, entitled “SELF-ADJUSTING SEATBELT FASTENER” (Attorney Docket No. 81127210/FGT 2267 PA), the disclosures of which are incorporated by reference herein.

### TECHNICAL FIELD

The present invention relates generally to seatbelt systems for vehicles, and more particularly to inflatable seatbelt systems for vehicles.

### BACKGROUND

Inflatable seatbelt systems for vehicles can play a pivotal role in occupant safety. A typical inflatable seatbelt system includes belt webbing configured for a three-point harness, which is comprised of a retractor, an inboard lap belt buckle, and an outboard lap belt anchor. The belt webbing typically extends between the retractor and the outboard lap belt anchor. Also, the belt webbing typically is slidably attached to a tongued latch plate, which is selectively fastened to the inboard lap belt buckle.

In inflatable systems, the belt webbing typically envelops or otherwise surrounds an elongated inflatable airbag that is inflated by an inflator device during a vehicle collision. This inflator device typically is contained within a rigid guide tube that is sewn within the belt webbing. In this respect, the rigid guide tube protects the movable inflator device and moves along with the inflator device. However, the movable inflator device and the guide tube can produce noise within the vehicle and thus increase NVH levels. Also, the movable inflator may require additional belt webbing and complex wiring. This webbing and wiring can induce a bumpy feel while the seatbelt is retracted or extracted from the retractor and thus diminish the tactile ergonomics of the seatbelt system. It will also be appreciated that the rigid tube can change the belt geometry in direct contact with the occupant and thus decrease an occupant's comfort.

The tongued latch plate typically has a slot for sliding belt webbing therethrough and securing a variety of different sized passengers within the vehicle seat. The slot can be somewhat narrow and cause the belt webbing to fold or overlap therein. In this regard, there may be significant friction between the belt webbing and the latch plate. Thus, it can be somewhat difficult to slide the latch plate along the belt webbing. In addition, the relatively narrow slots can restrict the flow of air within an inflatable seatbelt and diminish various inflation characteristics for the inflatable seatbelt. For instance, the restricted flow of air can adversely affect the inflation rate, peak pressure values, and steady-state pressure values.

Furthermore, existing seatbelt restraint systems have a shoulder belt anchor or guide loop that can be rotated only within a plane. In that way, the shoulder belt anchor may not be sufficiently positioned for flatly sliding the belt webbing therethrough. In this respect, belt webbing may fold or otherwise become lodged within the shoulder belt anchor and obstruct the extraction and/or retraction of the inflatable seatbelt.

It would therefore be desirable to provide an inflatable seatbelt system that prevents the belt webbing from folding and readily adjusts for a deployed inflatable seatbelt.

### SUMMARY OF THE INVENTION

One embodiment of the present invention is an inflatable seatbelt system (“seatbelt system”) for a vehicle. The seatbelt system includes a retractor, a shoulder belt anchor, a first lap belt anchor, a second lap belt anchor, an inflatable seatbelt, an inflator device, one or more crash sensors, a lap belt buckle, and a seatbelt fastener. The inflatable seatbelt extends between the shoulder belt anchor and the first lap belt anchor, with the inflator device fixedly attached to the first lap belt anchor. The inflator device is actuated by the crash sensors to inflate the inflatable airbag. Furthermore, the second lap belt anchor has the lap belt buckle extending therefrom, which is selectively fastened to the seatbelt fastener that is slidable on the inflatable seatbelt.

One advantage of the present invention is that a seatbelt system is provided that eliminates the noise, additional belt webbing, solid guide tubes, and somewhat complex wiring, which typically increase the cost of inflatable seatbelt systems and induce a bumpy or otherwise unpleasant feel when the seatbelt is extracted and retracted.

Another advantage of one embodiment of the claimed invention is that a seatbelt system is provided that easily slides a seatbelt fastener along belt webbing and otherwise enhances the comfort and performance of the seatbelt system.

Yet another advantage of one embodiment of the claimed invention is that a seatbelt system is provided that positions belt webbing substantially flat against a vehicle occupant's body and thus improves vehicle safety, as well as passenger comfort.

Still another advantage of one embodiment of the claimed invention is that a seatbelt system is provided that prevents belt webbing from becoming lodged in a seatbelt fastener, which can otherwise diminish the performance of an inflatable seatbelt.

Yet another advantage of one embodiment of the claimed invention is that a seatbelt system is provided that has a simple construction that can be produced on a large scale basis and thus provide an economy of scale.

Another advantage of one embodiment of the claimed invention is that a seatbelt system is provided that is efficiently packaged for easily integrating within a variety of vehicles without modification to the vehicle structure.

Yet another advantage of the claimed invention is that a seatbelt system is provided that is readily integrated within a variety of vehicles without changing the geometry of the seatbelt.

Still another advantage of one embodiment of the claimed invention is that a seatbelt system is provided that minimizes edge loading of a belt during a vehicle collision.

Yet another advantage of one embodiment of the claimed invention is that a seatbelt system is provided that has a robust construction for withstanding substantially high loads.

Other advantages of the present invention will become apparent upon considering the following detailed description and appended claims, and upon reference to the accompanying drawings.

### BRIEF DESCRIPTION OF THE DRAWINGS

For a more complete understanding of this invention, reference should now be made to the embodiments illustrated in greater detail in the accompanying drawings and described below by way of the examples of the invention:

FIGS. 1A and 1B are front plan views of an inflatable seatbelt system having a self-adjusting seatbelt fastener, respectively illustrating the system in undeployed and deployed configurations, according to one advantageous embodiment of the claimed invention;

FIGS. 2A and 2B are cross-sectional views of the inflatable seatbelt respectively shown in FIGS. 1A and 1B;

FIG. 3 is a front plan view of an inflatable seatbelt system, according to an alternative embodiment of the claimed invention;

FIG. 4 is a front plan, view of an inflatable seatbelt system, according to another alternative embodiment of the claimed invention;

FIGS. 5A and 5B are front plan views of the self-adjusting seatbelt fastener respectively shown in FIGS. 1A and 1B;

FIGS. 6A and 6B are front plan views of the self-adjusting seatbelt fastener, according to an alternative embodiment of the claimed invention;

FIG. 7 is an enlarged perspective view of a belt guide apparatus for the seatbelt restraint system shown in FIG. 1A;

FIGS. 8A and 8B are partially cutaway plan views of the belt guide apparatus shown in FIG. 7, illustrating the shoulder belt anchor respectively in a belt-flattening configuration and an offset configuration; and

FIGS. 9A and 9B are partially cutaway plan views of the shoulder belt anchor shown in FIG. 7, according to another advantageous embodiment of the claimed invention.

### DETAILED DESCRIPTION OF THE INVENTION

In the following figures, the same reference numerals are used to identify the same components in the various views.

The present invention is particularly suited for a vehicle having an inflatable seatbelt system with a self-adjusting seatbelt fastener and a shoulder belt anchor. In this way, the embodiments described herein employ structural features where the context permits. However, various other embodiments are contemplated having different combinations of the described features, having features other than those described herein, or lacking one or more of those features. For example, the seatbelt system may omit the self-adjusting seatbelt fastener and/or the shoulder belt anchor as desired. It is therefore contemplated that the invention can be carried out in a variety of other modes and utilized for other suitable applications.

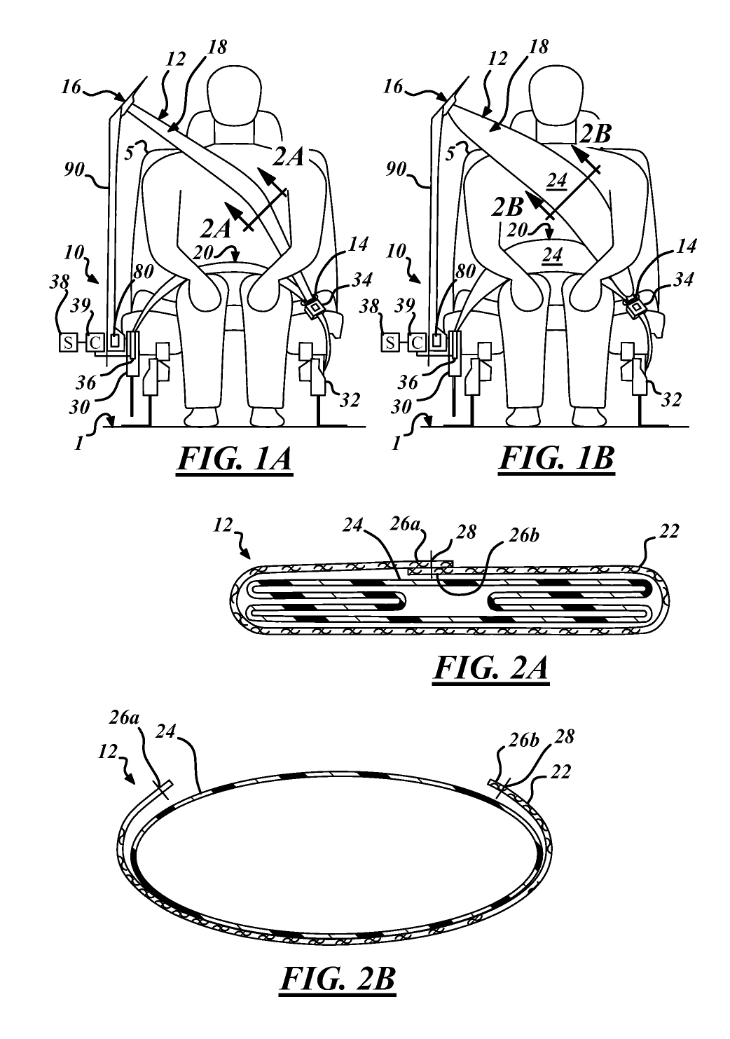

Referring to FIGS. 1A and 1B, there are shown front plan views of a vehicle 1 having a vehicle seat 5 and an inflatable seatbelt restraint system 10 (“seatbelt system”) comprised of an inflatable seatbelt 12, a self-adjusting seatbelt fastener 14 (“seatbelt fastener”), and a shoulder belt anchor 16 or guide loop, according to one advantageous embodiment of the claimed invention. FIGS. 1A and 1B respectively illustrate the seatbelt system 10 in undeployed and deployed configurations. As detailed below, the seatbelt fastener 14 decreases resistance to the inflation of the inflatable seatbelt 12 that would otherwise be associated with a conventional seatbelt fastener.

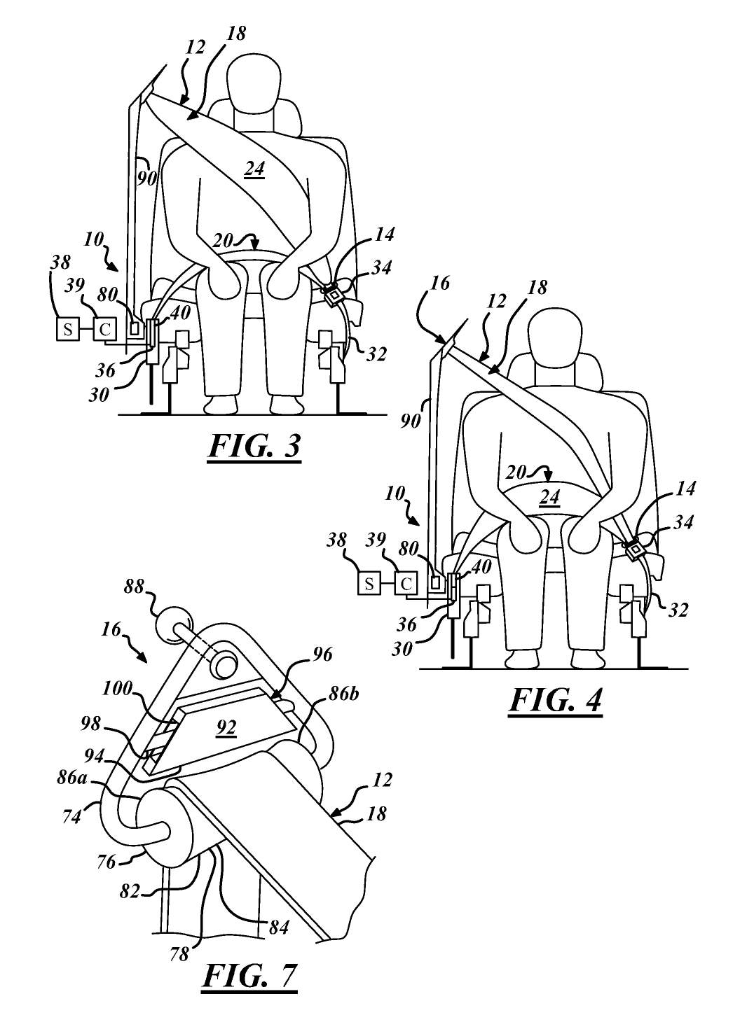

In this embodiment, the inflatable seatbelt 12 has a shoulder belt portion 18 and a lap belt portion 20, which as best shown in FIGS. 2A and 2B are both comprised of a belt webbing sleeve 22 and an elongated airbag 24. The sleeve 22 is conventional belt webbing that is folded with overlapping portions 26a, 26b sewn together by a rip seam 28. However, the webbing can instead be folded and fastened by a variety of other suitable ways. It will also be appreciated that the inflatable seatbelt 12 can have other suitable constructions, be integrated only within the shoulder belt portion 18 (shown in FIG. 3), or be integrated only within the lap belt portion 20 (shown in FIG. 4). For instance, with attention to FIG. 3, an airbag 24 disposed only within the shoulder belt portion 18 can be in open communication with the inflator device 36 by a sleeve (not shown) or other conduit extending through the lap belt portion 20.

Also, in this embodiment, the inflatable seatbelt 12 further includes infrangible webbing within the shoulder belt portion 18. In particular, the infrangible webbing is disposed within the sleeve 22 and in connection between an end portion of the airbag 24 and the retractor 80. In this respect, the inflatable seatbelt 12 is smoothly retracted and extracted from the retractor 80.

Referring back to FIGS. 1A and 1B, the seatbelt system 10 provides a three-point harness comprised of the retractor 80, an outboard lap belt anchor 30, and an inboard lap belt anchor 32. The inflatable seatbelt 12 extends through a guide loop or shoulder belt anchor 16 and between the retractor 80 and the outboard lap belt anchor 30. The inboard lap belt anchor 32 has a lap belt buckle 34 extending therefrom, which is selectively fastening to the seatbelt fastener 14 that is slidable on the inflatable seatbelt 12. However, it is contemplated that the system 10 can include more or less anchoring points, have single or multiple retractors 80, or have other suitable configurations as desired.

The seatbelt system 10 further includes an inflator device 36, one or more crash sensors 38, restraint control module 39, and the inflatable seatbelt 12. In this embodiment, the inflator device 36 is attached directly to the outboard lap belt anchor 30 in a fixed position. However, the inflator device 36 can instead be rotatably attached to the outboard lap belt anchor 30 so as to fit a variety of occupants. The inflator device 36 injects gas directly into the airbag 24 and inflates the lap belt portion 20 and then the shoulder belt portion 18. The inflator device 30 and the lap belt portion 20 can be configured to partially or fully inflate the lap belt portion 20.

In another embodiment shown in FIG. 3, the inflator device 36 is indirectly attached to the airbag 24 by a tube member 40 (shown in FIGS. 3 and 4). It will be appreciated that rigidly mounting the inflator device 36 to the outboard lap belt anchor 30 secures the inflator device 36 in a fixed location where there is a substantially low risk of damage to the inflator device 36. In addition, this configuration also eliminates additional webbing and complex wiring typically associated with movable inflator devices attached only to the seatbelt 12.

The crash sensors 38 are accelerometers with a mechanical configuration, an electromechanical configuration, or other suitable devices. In operation, the crash sensors 38 send a signal to the control module 39, which then actuates the inflator device 36. In this embodiment, the inflator device 36 is a stored gas mechanism that blasts cold air into the inflatable airbag 24 when the crash sensors 38 detect a vehicle collision. It is understood that the inflator device 36 can instead be various other suitable devices as desired.

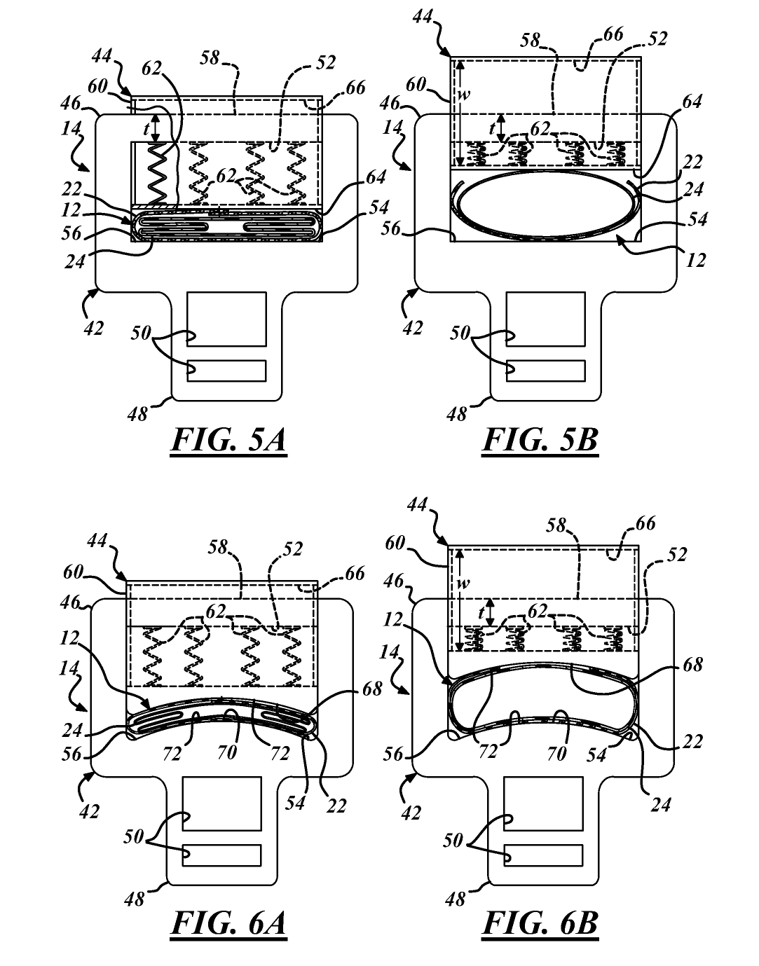

Referring now to FIGS. 5A and 5B, there are shown front plan views of the seatbelt fastener 14 respectively shown in FIGS. 1A and 1B. The seatbelt fastener 14 is comprised of a latch plate 42 and an urging mechanism 44, which is movable between a belt-flattening position (shown in FIG. 5A) and a clearance position (shown in FIG. 5B) on the latch plate 42.

The latch plate 42 includes a ring portion 46 and a tongue portion 48, which has one or more apertures 50 for fastening to the lap belt buckle 34 (shown in FIGS. 1A and 1B). The ring portion 46 has a first surface 52 and an opposing second surface 54, which define an opening 56 with the inflatable seatbelt 12 extending therethrough. The ring portion 46 has a bar structure 58 with the urging mechanism 44 slidably attached thereto.

The urging mechanism 44 is comprised of a shell 60 and one or more resilient members 62. As detailed below, the shell 60 has a guiding surface 64 extending substantially into the opening 56 in the latch plate 42 and flattening the belt webbing 22 therein.

The shell 60 defines a cavity 66 with the bar structure 58 of the latch plate 42 extending therethrough. The bar structure 58 has a predetermined thickness (t) and the cavity 66 has a predetermined width (W). Thus, the shell 60 is movable on the latch plate 42 by a predetermined travel distance.

The resilient members 62 are sandwiched between the shell 60 and the first surface 52 of the latch plate 42. In this way, the resilient members 62 force the shell 60 against the belt webbing 22 and flatten the inflatable seatbelt 12. This feature is beneficial for preventing the inflatable seatbelt 12 from folding, which could otherwise lodge the seatbelt 12 within the opening 56 and prevent the seatbelt fastener 14 from sliding along the belt webbing 22. In addition, flattening the inflatable seatbelt 12 sufficiently positions the inflatable seatbelt 12 for readily directing air between the shoulder belt portion 18 and the lap belt portion 20 of the inflatable airbag 24 and thus quickly deploying the airbag 24.

In this embodiment, the resilient members 62 are a series of helical springs having a predetermined coefficient of stiffness for sandwiching the seatbelt 12 between the shell 60 and the second surface 54 of the latch plate 42. In other words, the springs are sufficiently stiff for flattening the seatbelt 12. In addition, the springs are sufficiently deformable for moving the urging mechanism 44 to the clearance position and minimizing friction against the belt webbing 22. This feature is beneficial for easily sliding the belt webbing 22 through the seatbelt fastener 14. The springs are also sufficiently deformable for yielding to the force of the inflating airbag 24. It is contemplated that the resilient members 62 can have a variety of suitable constructions rather than helical springs. In addition, it will be appreciated that the resilient members 62 can have a two or more coefficients of stiffness along the cavity 66 for providing a variety of inflation characteristics. Examples of these inflation characteristics include the rate of inflation, peak pressure, and the steady-state pressure.

Referring now to the alternative embodiment shown in FIGS. 6A and 6B, the shell 60 has a concave surface 68 for centering the seatbelt 12 on the shell 60 and preventing the seatbelt 12 from bunching or otherwise folding near one side of the latch plate 42. Also in this embodiment, the second surface 54 of the latch plate 42 is a convex surface 70 for flattening the inflatable seatbelt 12 against the concave surface 68 of the urging mechanism 44. It is contemplated that the surfaces 68 and 70 can have a variety of suitable shapes, contours, and/or geometries.

In addition, the concave surface 68 of the urging mechanism 44 and the convex surface 70 of the latch plate 42 have a low-friction coating 72 for easily sliding the inflatable seatbelt 12 therebetween. The low-friction coating 72 is an electro-polish coating. However, it is understood that the seatbelt fastener 14 can instead have other suitable low-friction coatings or lack the same as desired.

With attention to FIG. 7, there is shown an enlarged perspective view of the shoulder belt anchor 16. The shoulder belt anchor 16 has a ring construction 74 for supporting and passing the inflatable seatbelt 12 therethrough. This ring construction 74 preferably has one or more generally flat interface portions 76 for distributing a load substantially across the width of the inflatable seatbelt 12. In other words, the ring construction 74 is sized and shaped for evenly supporting the inflatable seatbelt 12 and minimizing the concentration of a load in one or more discrete sections of the inflatable seatbelt 12. In this way, the inflatable seatbelt 12 can withstand a substantially high load.

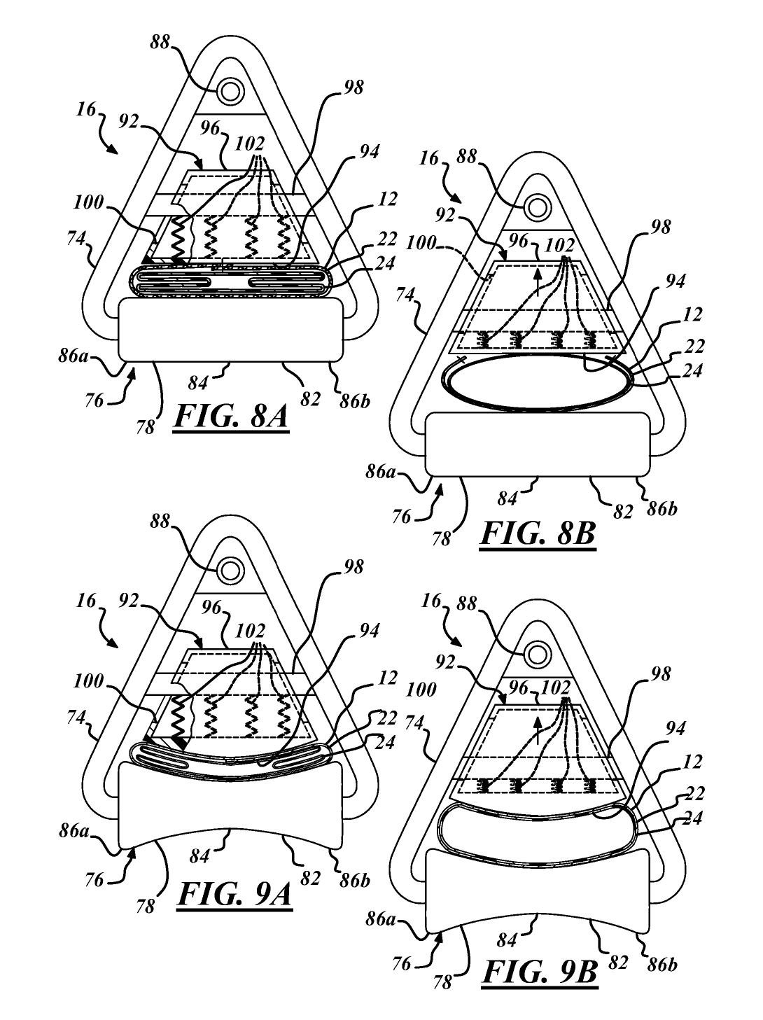

In this example, as detailed in the descriptions for FIGS. 8A and 8B, the ring construction 74 is generally triangular with the interface portion 76 being a straight roller member 78 rotatably coupled to the ring construction 74. However, it is contemplated that the ring construction 74 can have a variety of other suitable shapes, even ones without a generally flat interface portion 76 and/or a roller member 78.

In addition, it will also be appreciated that the flat interface portion 76 assists in preventing the inflatable seatbelt 12 from bunching together or otherwise folding over itself as the shoulder belt retractor 80 (shown in FIGS. 1A and 1B) winds the inflatable seatbelt 12. In this regard, the shoulder belt anchor 16 minimizes the risk of inflatable seatbelt 12 becoming tangled around the shoulder belt retractor 80 (shown in FIGS. 1A and 1B) and inadvertently locking or otherwise impeding the retractor 80 from retracting and/or releasing the inflatable belt 12.

Furthermore, this feature is beneficial for laying the shoulder belt portion 18 of the inflatable seatbelt 12 substantially flat across the chest of a vehicle occupant. In this way, the shoulder belt anchor 16 enhances the comfort of the vehicle occupant.

In the embodiments shown in FIGS. 9A and 9B, the interface portion 76 is a curved roller member 78 having a supporting surface 82 that is generally concave for maintaining the inflatable seatbelt 12 substantially flat on the roller member 78. In other words, the roller member 78 has a center portion 84 and opposing end portions 86a, 86b that are thicker than the center portion 84. For this reason, the seatbelt 12 does not move laterally across the roller member 78 and fold or otherwise bunch up against one side of the ring construction 74. It is contemplated that the supporting surface 82 can have various other suitable contours for maintaining the seatbelt 12 on the interface portion 76.

Also, in this embodiment, the ring construction 74 of the shoulder belt anchor 16 has a pivotal fastener 88 (best shown in FIG. 7) for mounting the shoulder belt anchor 16 to a vehicle pillar 90 (shown in FIGS. 1A and 1B). Specifically, the pivotal fastener 88 is utilized for moving the shoulder belt anchor 16 in the direction of the seatbelt loading, e.g. along at least three axes. In this way, the seatbelt 12 remains substantially flat against the shoulder belt anchor 16 and provides the various advantages described hereinabove.

Specifically, in this embodiment, the pivotal fastener 88 is a substantially spherical protrusion and is utilized for being contained within a socket (not shown) formed in the vehicle pillar 90. However, it will be appreciated that the pivotal fastener 88 can be various other suitable fasteners. For instance, the socket can instead be formed within the shoulder belt anchor 16 for receiving a substantially spherical protrusion extending from the vehicle pillar 90.

The shoulder belt anchor 16 further includes a biasing mechanism 92 for selectively forcing the inflatable seatbelt 12 substantially flat against the interface portion 76. FIG. 8A shows the biasing mechanism 92 in a belt-flattening configuration with the undeployed inflatable belt 12 sandwiched between a belt-adjusting surface 94 of the biasing mechanism 92 and the supporting surface 82 of the interface portion 76. Figure shows the biasing mechanism 92 moved to an offset configuration by the deployed inflatable seatbelt 12.

In this embodiment, the biasing mechanism 92 includes a housing 96, which is slidably coupled to a cross member 98 of the ring construction 74. This housing 96 has a channel 100 formed therethrough which is sized for receiving the cross member 98 and moving the housing 96 between the belt-flattening configuration and the offset configuration.

The biasing mechanism 92 further includes one or more biasing members 102 for forcing the biasing mechanism 92 to the belt-flattening configuration. In this embodiment, the biasing members 102 are helical springs. However, the biasing members 102 can have other suitable constructions. The springs are sandwiched between the cross member 98 and the supporting surface 82 of the housing 96. It will be appreciated that the biasing mechanism 92 can instead be comprised of an elastic material for deforming to a variety of shapes, e.g. concave, as the airbag 24 is inflated.

Moreover, the springs are sufficiently stiff for pressing the inflatable seatbelt 12 substantially flat against the interface portion 76 while allowing the inflating airbag 24 to force the biasing mechanism 92 to the offset configuration.

In another embodiment shown in FIGS. 9A and 9B, the biasing mechanism 92 has a generally downwardly curved surface 94 for flattening the seatbelt 12. In this regard, a substantial portion of the biasing mechanism 92 contacts the seatbelt 12 as desired.

While particular embodiments of the invention have been shown and described, it will be understood, of course, that the invention is not limited thereto since modifications may be made by those skilled in the art, particularly in light of the foregoing teachings. Accordingly, it is intended that the invention be limited only in terms of the appended claims.

What is claimed is:

1. An inflatable seatbelt system for a vehicle, comprising:
a shoulder belt anchor;
a pair of lap belt anchors comprised of a first lap belt anchor and a second lap belt anchor;
said first lap belt anchor fixedly attached to said vehicle;
an inflatable belt extending between said shoulder belt anchor and said first lap belt anchor;
an inflator device fixedly attached to said first lap belt anchor and inflating said inflatable seatbelt;
at least one crash sensor coupled to said inflator device and actuating said inflator device to inflate said inflatable belt;
a lap belt buckle extending from said second lap belt anchor; and
a seatbelt fastener slidable on said inflatable seatbelt for selectively fastening to said lap belt buckle.

2. The inflatable seatbelt system recited in claim 1 wherein said inflator device is attached directly to said inflatable seatbelt within said first lap belt anchor.

3. The inflatable seatbelt system recited in claim 1 wherein said inflator device is attached to said inflatable seatbelt by a tube member.

4. An inflatable seatbelt system for a vehicle, comprising:
a shoulder belt anchor;
a pair of lap belt anchors comprised of an outboard lap belt anchor and an inboard lap belt anchor;
said outboard lap belt anchor fixedly attached to said vehicle;
an inflatable belt extending between said shoulder belt anchor and said outboard lap belt anchor;
an inflator device fixedly attached to said outboard lap belt anchor and inflating said inflatable seatbelt;
at least one crash sensor coupled to said inflator device and actuating said inflator device to inflate said inflatable belt;
a lap belt buckle extending from said inboard lap belt anchor; and
a seatbelt fastener slidable on said inflatable seatbelt for selectively fastening to said lap belt buckle;
said shoulder belt anchor pivotally coupled to a vehicle structure along at least three axes;
said shoulder belt anchor supporting said inflatable belt and minimizing an edge loading on said inflatable belt.

5. The inflatable seatbelt system recited in claim 4 wherein said pivotal fastener and said vehicle structure comprise a ball-and-socket coupling for moving the belt guide member in said at least three directions.

6. The inflatable seatbelt system recited in claim 4 wherein said shoulder belt anchor has an interface portion with a concave supporting surface for biasing said inflatable belt toward a center portion of said interface portion.

7. The inflatable seatbelt system recited in claim 6 wherein said interface portion has said center portion and a pair of opposing end portions that are thicker than said center portion.

8. The inflatable seatbelt system recited in claim 4 wherein said shoulder belt anchor comprises:
a ring construction with a cross member; and
a biasing mechanism attached to said cross member and flattening said inflatable belt.

9. The inflatable seatbelt system recited in claim 8 wherein said biasing mechanism is comprised of a housing coupled to said cross member and at least one biasing member between said housing and said cross member for forcing said housing onto said inflatable belt and maintaining said inflatable belt substantially flat against said interface portion.

10. The inflatable seatbelt system recited in claim 9 wherein said housing has a channel for receiving said cross member.

11. The inflatable seatbelt system recited in claim 10 wherein said channel is sized for moving said biasing mechanism by a predetermined distance between a belt-flattening configuration and an offset configuration.

12. The inflatable seatbelt system recited in claim 9 wherein said housing has a concave belt-adjusting surface for substantially flattening said inflatable belt against a convex surface of said interface portion of said belt member guide.

13. The inflatable seatbelt system recited in claim 12 wherein said convex surface is sized for substantially receiving said concave belt-adjusting surface.

14. The inflatable seatbelt system recited in claim 4 wherein said interface portion is comprised of a roller member that is rotatably coupled to said ring construction.

15. A vehicle comprising:
a vehicle seat; and
said inflatable seatbelt system recited in claim 4 securing a vehicle occupant in said vehicle seat.

16. An inflatable seatbelt system for a vehicle, comprising:
a shoulder belt anchor;
a pair of lap belt anchors comprised of an outboard lap belt anchor and an inboard lap belt anchor;
an inflatable belt extending between said shoulder belt anchor and said outboard lap belt anchor;
an inflator device attached to said outboard lap belt anchor and inflating said inflatable seatbelt;
at least one crash sensor coupled to said inflator device and actuating said inflator device to inflate said inflatable belt;
a lap belt buckle extending from said inboard lap belt anchor; and
a seatbelt fastener slidable on said inflatable seatbelt for selectively fastening to said lap belt buckle;
said seatbelt fastener comprised of a latch plate and an urging mechanism;
said latch plate having a ring portion and a tongue portion;
said ring portion defining an opening with said belt webbing extending therethrough;
said tongue portion fastening to said lap belt buckle;
said urging mechanism slidably attached to said ring portion and extending substantially into said opening;
said urging mechanism substantially flattening said belt webbing within said opening of said ring portion.

17. The inflatable seatbelt system recited in claim 16 wherein said urging mechanism comprises:
a shell slidably attached to said ring portion of said latch plate; and
at least one resilient member sandwiched between said shell and said ring portion;
said at least one resilient member forcing said shell against said belt webbing.

18. The inflatable seatbelt system recited in claim 17 wherein said ring portion has a first surface and an opposing second surface defining said opening with said at least one resilient member sandwiched between said first surface and said shell.

19. The inflatable seatbelt system recited in claim 17 further comprising:
said shoulder belt anchor having a pivotal fastener, an interface portion, a biasing mechanism, and a ring construction with a cross member;
said pivotal fastener pivotally attached to said vehicle structure;
said interface portion extending from said pivotal fastener and supporting said inflatable belt therein;
said biasing mechanism movable between a belt-flattening configuration and an offset configuration;
said biasing mechanism in said belt-flattening configuration pressing said inflatable belt substantially flat against said interface portion;
said biasing mechanism in said offset configuration offset a predetermined distance from said interface portion for providing room for said inflatable belt to inflate;
said pivotal fastener moving said shoulder belt anchor in at least three directions for maintaining said inflatable belt substantially flat against said interface portion.

20. The inflatable seatbelt system recited in claim 19 wherein said biasing mechanism is comprised of a housing coupled to said cross member and at least one biasing member sandwiched between said housing and said cross member.
